(19) United States
(12) Patent Application Publication
(10) Pub. No.: US 2004/0139824 A1
(43) Pub. Date: Jul. 22, 2004

(54) Engaging ring with a larger area of outer tooth of ratchet tools

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/347,204

(22) Filed: Jan. 21, 2003

(51) Int. Cl. B25B 13/46

(52) U.S. Cl. 81/63.2

(57) ABSTRACT

A ratchet tool includes a head with a hole so as to receive an engaging ring therein. A first opening and a second opening are respectively defined in two sides of the head. A first stepped portion and a second stepped portion are respectively defined in an inside of a periphery of the first opening and the second opening. Two necks respectively extend from two opposite ends of the engaging ring. An outer diameter of the necks is smaller than an outer diameter of the teeth on the engaging ring which is engaged with a pawl in the head. One of the necks has a flange extending outward from a distal edge thereof so as to define a groove between an end of the teeth and the flange. The two necks are engaged with the two stepped portions. A C-shaped clamp is engaged with the groove and the stepped portion corresponding thereto.

### FIELD OF THE INVENTION

The present invention relates to an engaging ring of a ratchet tool and a groove is defined in an outer periphery thereof so as to receive a C-shaped clamp. The groove is ended at an end of the teeth defined in an outer periphery of the engaging ring.

### BACKGROUND OF THE INVENTION

A first conventional ratchet tool is shown in FIG. 1 and generally includes an engaging ring 12 that is rotatably received in a head 10 of the tool and teeth 15 are defined in an outer periphery of the engaging ring 12. A pawl 11 is received in the head and engaged with the teeth 15 of the engaging ring 12. The engaging ring 12 has a groove 14 defined in the outer periphery thereof and includes a first flange 141 and a second flange 142. The first flange 141 occupies an area in the height direction of the outer periphery of the engaging ring 12 and reduces the area that the teeth 15 occupy. A C-shaped clamp 13 is engaged with the groove 14 to position the engaging ring 12 in the head 10. The shorter teeth 15 limit the torque that can be output by the tool.

FIG. 2 shows another conventional ratchet tool wherein the head has a groove 14′ defined in a periphery of the hole defined through the head. Similarly, the groove 14′ is defined between two flanges 141′, 142′ and an engaging ring (not shown) is rotatably received in the hole. A pawl (not shown) is received in a chamber 16 defined in an inner periphery of the hole so as to engage with the engaging ring. Nevertheless, this type of ratchet tool needs a cover that is engaged with the groove 14′ so as to position the engaging ring in the hole of the head.

FIGS. 3 and 4 disclose two different types of conventional ratchet tools, they are suffered by the same problem as described in FIG. 1 and the connection portion “A” and “B” requires a groove defined in the engaging ring.

The present invention intends to provide a ratchet tool that has an engaging ring wherein the groove is ended at an end of the teeth on the outer periphery of the engaging so that the length of the teeth are longer than the conventional teeth.

### SUMMARY OF THE INVENTION

In accordance with one aspect of the present invention, there is provided a ratchet tool which comprises a head which has a hole defined therethrough and a first opening and a second opening are respectively defined in a first side and a second side of the head. A first stepped portion is defined in an inside of a periphery of the first opening and a second stepped portion is defined in an inside of a periphery of the second opening.

An engaging ring has teeth defined longitudinally in an outer periphery thereof and is rotatably received in the hole of the head. Two necks respectively extend from two opposite ends of the engaging ring. An outer diameter of the necks is smaller than an outer diameter of the teeth on the engaging ring so that the teeth are engaged with a pawl received in the head. One of the necks each has a flange extending outward from a distal edge thereof so as to define a groove between an end of the teeth and the flange. The other neck is engaged with the first stepped portion. A C-shaped clamp is engaged with the groove and the second stepped portion.

The primary object of the present invention is to provide an engaging ring wherein the length of the teeth on the outer periphery of the engaging ring is longer than those of conventional engaging ring.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional ratchet tool;

FIG. 2 shows a head, partly removed, of a conventional ratchet tool;

FIGS. 3 and 4 shows two conventional ratchet tools;

FIG. 5 is an exploded view to show the ratchet tool of the present invention;

FIG. 6 shows the head of the ratchet tool of the present invention;

FIG. 7 shows a cross sectional view of the ratchet tool of the present invention;

FIG. 8 shows another embodiment of the ratchet tool of the present invention, and

FIG. 9 is an exploded view to show another embodiment of the ratchet tool of the present invention.

### DETAILED DESCRIPTION OF THE PREFERRED EMBODIMENT

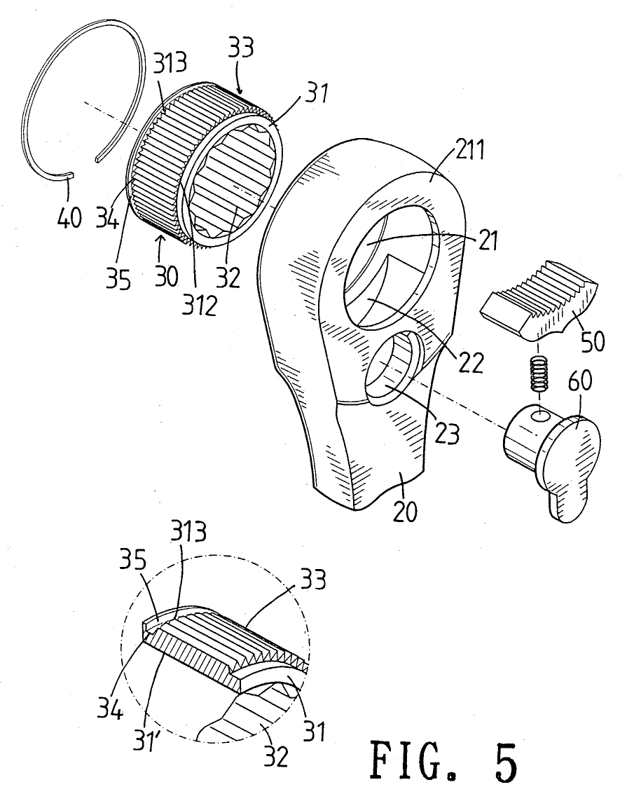

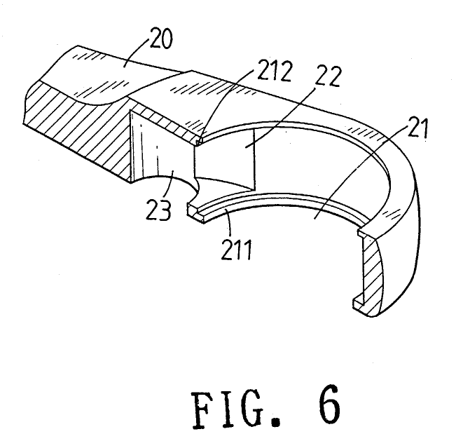

Referring to FIGS. 5 and 6, the ratchet tool of the present invention comprises a head 20 having a hole 21 defined therethrough for receiving an engaging ring 30 therein and a chamber 22 is defined in an inner periphery of the hole 21 for receiving a pawl 50 therein. A first opening is defined in a first side of the head 20 and communicates with the hole 21. A first stepped portion 211 is defined in an inside of a periphery of the first opening. A second opening is defined in a second side of the head 20 and communicates with the hole 21. A second stepped portion 212 is defined in an inside of a periphery of the second opening.

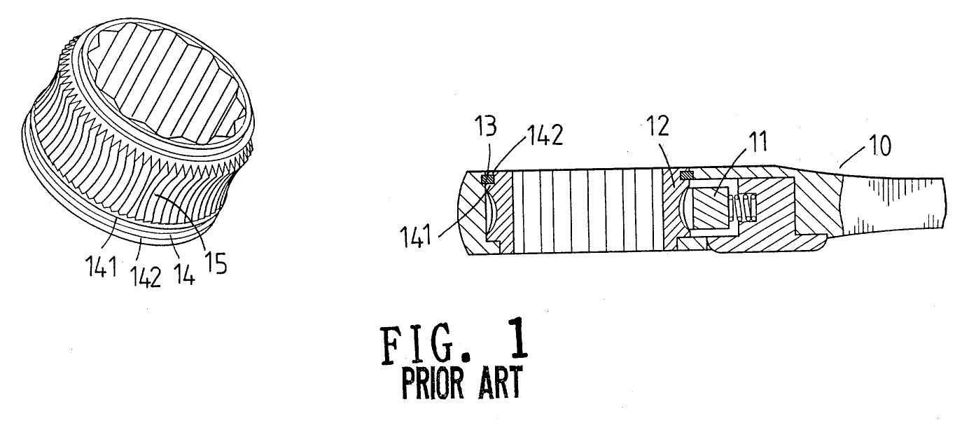

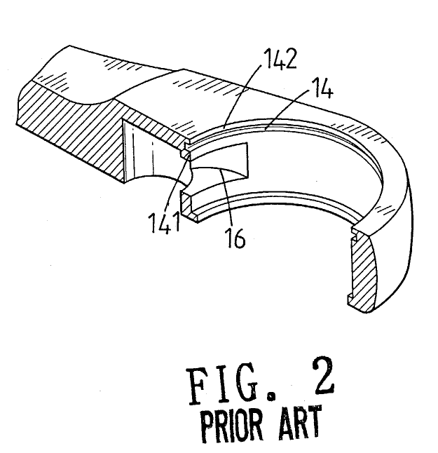

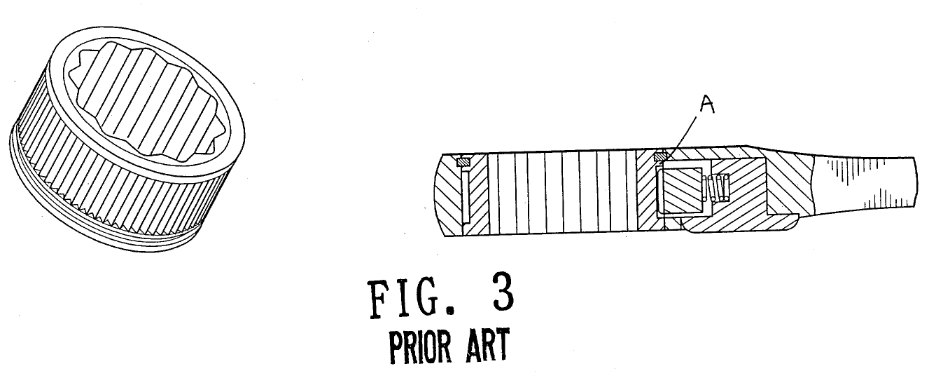

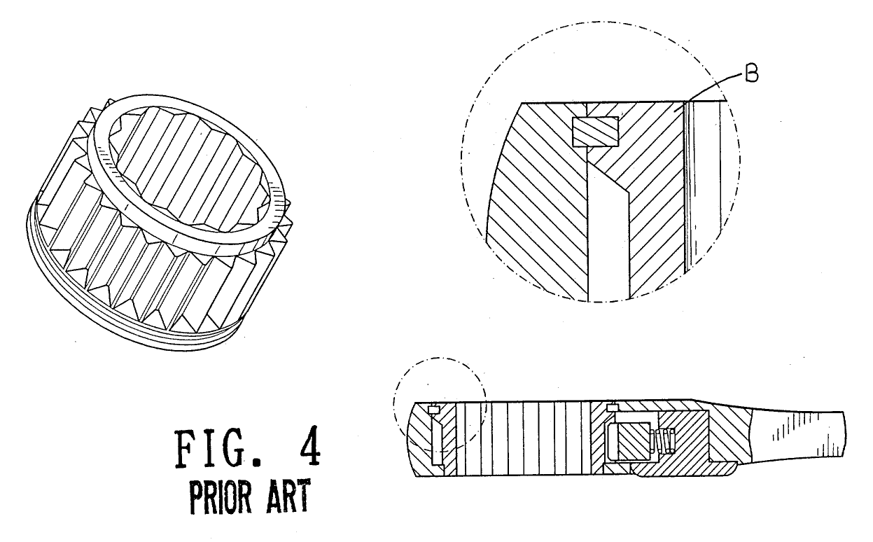

The engaging ring 30 has teeth 33 defined longitudinally in an outer periphery thereof and two necks 31, 31′ respectively extend from two opposite ends of the engaging ring 30. An outer diameter of the necks 31, 31′ is smaller than an outer diameter of the teeth 33 on the engaging ring 30 so that the teeth 33 can be engaged with the engaging teeth defined in a side of the pawl 50. The necks 31′ has a flange 35 extending outward from a distal edge thereof so as to define a groove 313 between an end 313 of the teeth 33 and the flange 35. In other words, in comparison with the conventional engaging ring, the teeth 33 can extend further because there is no “flange 141” as disclosed in the conventional engaging ring in FIG. 1.

The engaging ring 30 is rotatably received in the hole 21 and the neck 31 is engaged with the first stepped portion 211. A C-shaped clamp 40 is engaged with the groove 34 and the second stepped portion 212. This makes the installation of the engaging ring 30 be convenient and easily by simply inserting the C-shaped clamp 40 into the groove 34. Besides, the manufacturing cost is expected to be reduced.

A hole 23 is defined in the first side of the head 20 and communicates with the chamber 22. A control member 60 is rotatably received in the hole 23 so as to push the other side of the pawl 50 toward the engaging ring 30.

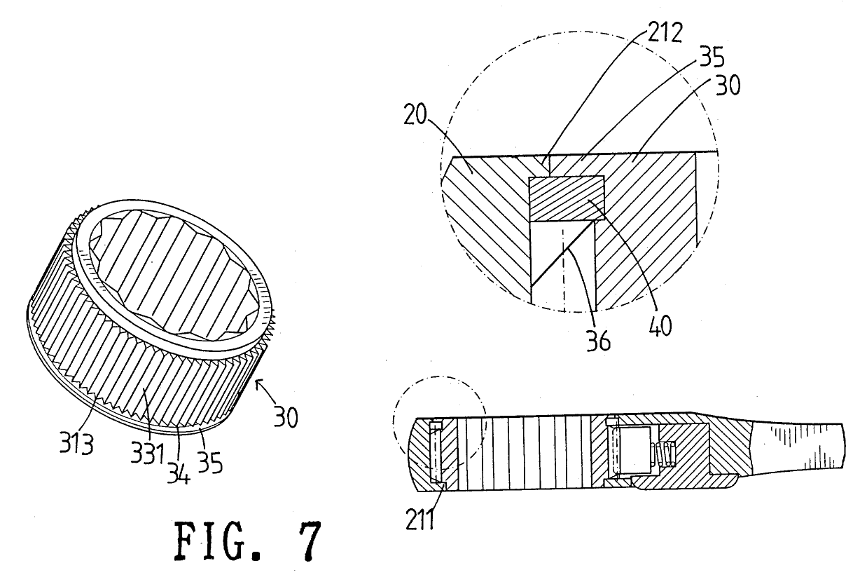

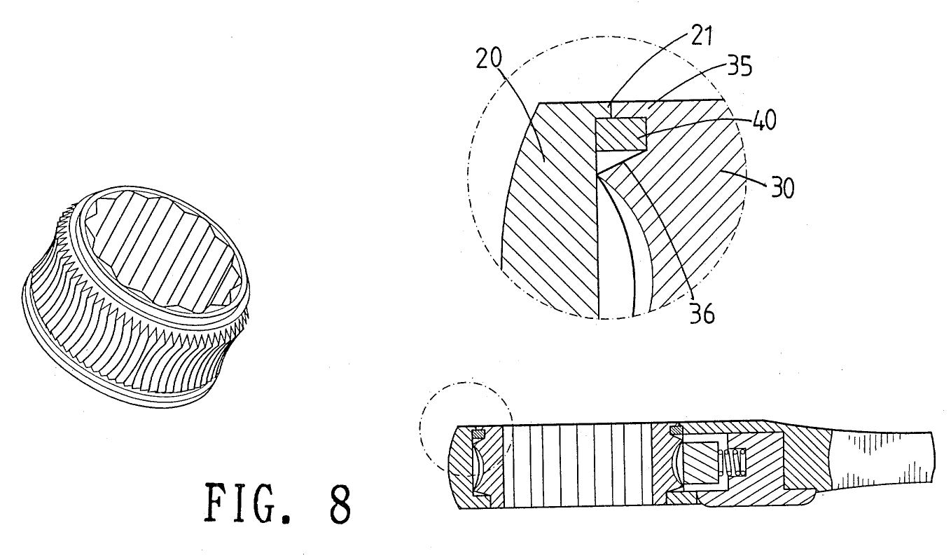

Referring to FIG. 7, the end 313 of the teeth 33 has an inclined edge 36 so that a gap is defined between the end 313 of the teeth 33 and the C-shaped clamp 40. By this arrangement, the friction between the teeth 33 and the C-shaped clamp 40 can be reduced. FIG. 8 shows the engaging ring 30 has different type of teeth 30.

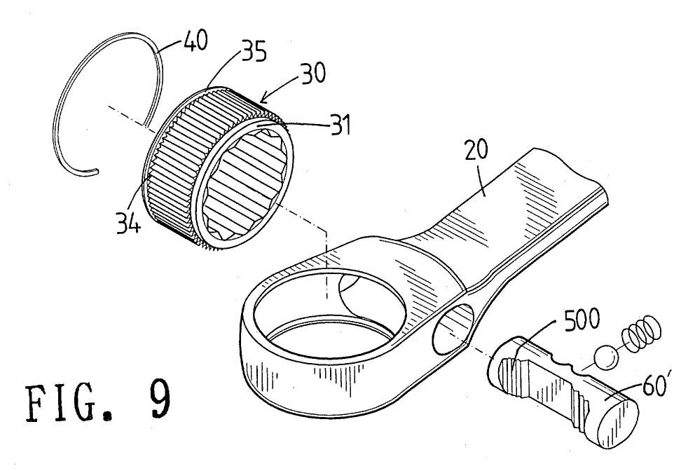

Referring to FIG. 9, the control member 60′ can be installed to the head from a lateral side of the head and is combined with the pawl 50. The control member 60 is an elongate bar and includes two toothed portions 500 which perform as the pawl 50.

While we have shown and described the embodiment in accordance with the present invention, it should be clear to those skilled in the art that further embodiments may be made without departing from the scope of the present invention.

What is claimed is:

1. A ratchet tool comprising:
a head having a hole defined therethrough and a chamber defined in an inner periphery of the hole, a first opening defined in a first side of the head and communicating with the hole, a first stepped portion defined in an inside of a periphery of the first opening, a second opening defined in a second side of the head and communicating with the hole, a second stepped portion defined in an inside of a periphery of the second opening;
an engaging ring having teeth defined longitudinally in an outer periphery thereof and two necks respectively extending from two opposite ends of the engaging ring, an outer diameter of the necks being smaller than an outer diameter of the teeth on the engaging ring, one of the necks having a flange extending outward from a distal edge thereof so as to define a groove between an end of the teeth and the flange, the engaging ring rotatably received in the hole and the other neck engaged with the first stepped portion, a C-shaped clamp engaged with the groove and the second stepped portion, and
a pawl received in the chamber and having engaging teeth defined in a side thereof, the engaging teeth engaged with the teeth of the engaging ring, a control member operatively connected to the other side of the pawl.

2. The ratchet tool as claimed in claim 1, wherein the end of the teeth has an inclined edge so that a gap is defined between the end of the teeth and the C-shaped clamp.
